(19) United States
(12) Patent Application Publication
(10) Pub. No.: US 2006/0078850 A1
(43) Pub. Date: Apr. 13, 2006

(54) Systems, methods and compositions for promoting oral hygiene

(76) Inventor: Suraj Puri, Los Altos, CA (US)

Correspondence Address: DECHERT LLP, P.O. BOX 10004, PALO ALTO, CA, 94303, US

(21) Appl. No.: 10/965,697

(22) Filed: Oct. 13, 2004

(51) Int. Cl. A61C 15/00

(52) U.S. Cl. 433/216

(57) ABSTRACT

Systems, methods and compositions for promoting oral hygiene are described. According to the present invention, oral hygiene is promoted by the use of a charged solution on the mouth tissue. Inventive methods for producing the cleaning solution includes charging a solution, which contains at least a solute selected to promote cleaning of tissue present in mouth. As a result of charging, at least a portion of the solute is present as clusters in the charged solution. Inventive systems for producing the cleaning solution includes: (1) a charging chamber for holding a solution, which contains at least a solute selected to promote oral hygiene; and (2) a first acoustic energy source capable of vibrating said solution in said charging chamber to produce a charged solution, wherein at least a portion of said solute is present as clusters in said charged solution.

### FIELD OF THE INVENTION

The present invention relates to systems and methods for effectively cleaning different type of tissues present in the mouth, such as teeth, tongue and gums. More particularly, the present invention relates to systems and methods for effectively cleaning such mouth tissue using a charged cleaning solution such that, at least a portion of the solute particles in that cleaning solution are present in cluster form, as solute clusters. The present invention also provides compositions for effective cleaning of mouth tissue.

### BACKGROUND OF THE INVENTION

Oral hygiene has consistently strived to devise new designs, methods and compositions for removing various contaminants that adhere to the different tissue present in mouth, such as tongue, teeth and gums. To date, the basic process for cleaning has not been able to remove a substantial amount of the original bacteria, viruses, and very small contaminants, from and in and around the boundary layer of the mouth tissue. This is borne out by the fact that regardless of how and how many times a day people brush their teeth, for example, after every few months they must still pay a visit to a dentist to have their teeth cleaned to remove, among other contaminants, plaque. Plaque is the build up of dead and live bacteria, viruses and other such contaminants which reside in the mouth.

What is therefore needed is an improved system, process or composition which promotes oral hygiene by removing from the mouth tissue a substantial amounts of contaminants, including plaque.

### SUMMARY OF THE INVENTION

To achieve the foregoing, the present invention provides systems, methods and compositions for promoting oral hygiene by removing if not all, a substantial amount of contaminants found in the mouth. The present invention accomplishes this by cleaning mouth tissue using a charged solution. Specifically, the present invention provides systems, methods and compositions for producing a solution which promotes oral hygiene. Based on these inventions, the present invention also provides inventive methods of facilitating oral hygiene.

In one aspect the present invention provides a method for producing a solution which promotes oral hygiene. The method includes charging a solution, which contains at least a solute selected to promote cleaning of tissue present in mouth, wherein as a result of charging, at least a portion of the solute is present as clusters in the charged solution. The charging step may be carried out by providing acoustic energy, for example by vibrating the solution to produce at least the portion of the solute in cluster form. Such vibrating may be caused by sonic energy, which could be either ultrasonic energy or megasonic energy. The acoustic energy may be produced by a sonic device. The tissue present in mouth includes, but is not limited to, any one member selected from the group consisting of tongue, teeth and gums.

In accordance with one embodiment, the solute is any one member selected from the group consisting of ammonium hydroxide, mouthwash and diluted solution of tooth paste. An average number of molecules of the solute in the clusters may be between about 100 and about 200 molecules per cluster. The step of charging may further include diluting the solution such that the solute is present in a solvent in a volumetric ratio that is between about 5×10⁻⁵:1 and about 1×10⁻²⁴:1. In one preferred embodiment, the solute is present in the solvent in a volumetric ratio that is between about 1×10⁻⁶:1 and about 1×10⁻²⁴:1. In a more preferred embodiment, the solute is present in the solvent in a volumetric ratio that is between about 1×10⁻⁸: 1 and about 1×10⁻²⁴:1.

In one embodiment of the present invention, the method for producing a solution which promotes oral hygiene further includes: (1) diluting said charged solution to produce a cleaning solution; and (2) using said cleaning solution for promoting said oral hygiene. In yet another embodiment of the present invention, the method includes mixing a solvent and said solute to produce said solution before the step of charging of the solution is implemented. In this embodiment, the solvent is typically deionized water. The step of mixing produces the solution having the solute present in the solvent in a volumetric ratio that is between about 3×10⁻⁵:1 and about 1×10⁻²⁴:1.

In another aspect, the present invention provides a system for making a cleaning solution which promotes oral hygiene. The system includes: (1) a charging chamber for holding a solution, which contains at least a solute selected to promote oral hygiene; and (2) a first acoustic energy source capable of vibrating said solution in said charging chamber to produce a charged solution, wherein at least a portion of said solute is present as clusters in said charged solution.

One embodiment of the inventive systems further include a mixing chamber for mixing a solvent and the solute to produce the solution. Other embodiments of the inventive systems further include a connection which allows communication between the charging chamber and an exit stream of the mixing chamber such that the solvent and solute combine with the contents of the charging chamber to produce an effective cleaning solution.

In yet another aspect, the present invention provides a method for facilitating oral hygiene. The method includes applying a charged solution to tissue present in mouth; and providing sonic energy to the charged solution contained in the mouth. In one embodiment of the present invention, the steps of applying and providing are carried out by a sonic tooth brush that includes a mechanism of providing the charged solution within the mouth and provides sonic energy when the sonic tooth brush is activated. In another embodiment of the present invention, the steps of applying and providing are carried out by a dental tray which contains the charged solution and the dental tray includes a mechanism of providing sonic energy when the mechanism to supply sonic energy is activated. It is also possible that the step of providing is carried out by using ultrasonic energy.

In yet another aspect, the present invention provides a composition of a solution for promoting oral hygiene. The oral hygiene composition includes a solute selected to promote cleaning of tissue present in mouth, wherein at least a portion of the solute is present in cluster form in the solution. The oral hygiene composition typically includes a solvent. The solute, e.g., ammonium hydroxide, and the solvent, e.g., deionized water, are present in a volumetric ratio that may be between about 1:1 and about 1×10⁻²⁴:1. The solute may be one member selected from the group consisting of mouth wash, diluted solution containing tooth paste.

In one embodiment of the present invention, the solute and solvent are present in a volumetric ratio that is between about 1×10⁻⁵:1 and about 1×10⁻²⁴:1. In a preferred embodiment, the solute and solvent are present in a volumetric ratio that is between about 1×10⁻⁷:1 and about 1×10⁻²⁴:1. In a more preferred embodiment, the solute and solvent are present in a volumetric ratio that is between about 1×10⁻⁴:1 and about 1×10⁻⁸:1. The tissue present in mouth, which undergoes cleaning, includes any one member selected from the group consisting of teeth, tongue and gums.

In yet another aspect, the present invention provides a method for promoting oral hygiene. The method for promoting oral hygiene includes: (1) applying a charged solution to tissue present in mouth, which contains at least a solute selected to promote cleaning of tissue present in mouth including any one of tongue, teeth and gums, wherein at least a portion of the charged solution contains solute in clusters form; and (2) providing sonic energy to said charged solution when it is present in said mouth to effectively remove particle matter adhering to tissue present in the mouth.

These and other features of the present invention will be further described in the following detailed description of the invention with reference to the associated drawings.

### BRIEF DESCRIPTION OF THE FIGURES

FIG. 1 is a diagram of a system, according to one embodiment of the present invention, for producing a solution that promotes oral hygiene.

FIG. 2A shows the random distribution of the solute particles in an uncharged solution.

FIG. 2B shows the solute particles arranged in cluster form in a charged solution, according to one embodiment of the present invention.

### DETAILED DESCRIPTION OF THE INVENTION

The present invention provides systems, methods and compositions for promoting oral hygiene. Conventional wisdom dictates that for effectively cleaning mouth tissue, high enough concentrations of a solute, which is typically an active cleaning ingredient in the cleaning solution, should be used. According to such wisdom, it is believed that high concentrations of the solute react with the boundary of the different mouth tissue to detach contaminant therefrom. Predicated on this belief, conventional wisdom teaches away from using cleaning solutions with relatively low solute concentrations or low concentration of the active ingredient in the cleaning process.

In the present invention, however, relatively low solute concentrations of the solute are preferred because they promote charging of a solution. For more information on the concept of charging, reference can be made to U.S. patent application Ser. No. 10/886,785, filed on Jul. 7, 2004 and entitled “Systems and Methods for Charging a Cleaning Solution Used for Cleaning Integrated Circuit Substrates,” which is incorporated herein by reference for all purposes. It is believed that in a charged solution, solute particles are arranged as clusters. It is also believed that these solute clusters trap detached contaminant particles for effective removal from the mouth tissue. As a result, the present invention focuses on forming solute clusters for effective tissue cleaning. Notably, the inventive cleaning systems, methods and compositions described herein not only provide a way to clean mouth tissue using relatively low solute concentrations, which are deemed ineffective by conventional cleaning techniques, rather such low solute concentrations represent preferred embodiments of the present invention.

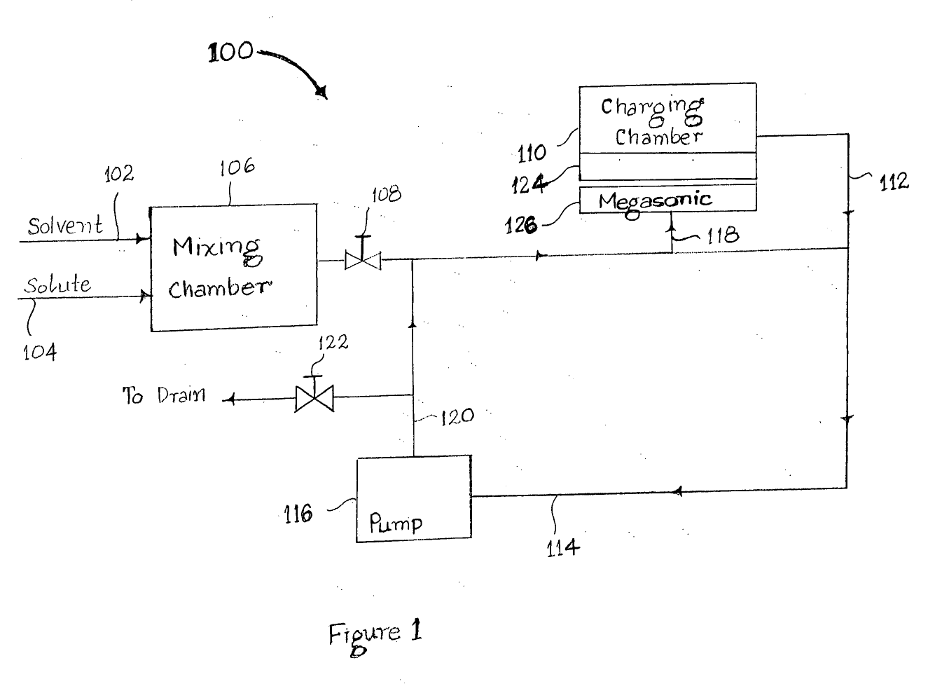

FIG. 1 shows a cleaning system 100, according to one embodiment of the present invention, for producing a charged solution that facilitates cleaning of the mouth tissue. System 100 is shown to have two chambers—a mixing chamber 106 for mixing a solute stream 104 and a solvent stream 102 to form a solution, and a charging chamber 110 for charging the solution formed in mixing chamber 106. A valve 108 is activated to convey the contents of mixing chamber 106 to charging chamber 110. Charging chamber 110 comes equipped with a first acoustic energy source 126 and a coupling chamber 124 for coupling the continuous energy transmission into the charging chamber.

A first connection 118 between mixing chamber 106 and charging chamber 110 allows the uncharged solution to be conveyed from chamber 106 to chamber 110 for charging. After the solution inside chamber 110 is charged, a pump 116 conveys the charged solution from that chamber via a second connection 112, an optional third connection 114, an optional fourth connection 120 to drain or, in the alternative, for further recharging back to chamber 110. In one embodiment, in system 100, a valve 122 and a fourth connection 120 facilitates conveying the charged solution to drain where it is recovered for use. Typically, drain here represents a location where the charged solution may be retrieved and then stored in a vial or container and can be subsequently used by a user to promote oral hygiene. If the solution in chamber 110 is not charged to the desired extent, the same pathway (i.e. connections 112, 114 and 120) direct the charged solution to combine with the uncharged solution exiting from chamber 106. The combination of these two streams is introduced into chamber 110 for further charging.

Mixing chamber 106 may be any equipment known in the art that can controllably combine a flow of at least one liquid with a flow of at least one gas. Charging chamber 110 can be made of any material known to be a good transmitter of acoustic energy. This chambers is preferably made from quartz. Although FIG. 1 describes two chambers as two separate vessels, it is possible that the two chambers could be incorporated into a single vessel. The preferred embodiment, however, is to have two separate vessels as shown in FIG. 1.

Acoustic energy source 126 can be any source that supplies megasonic energy and the like. Charging chamber 110 is ideally placed above acoustic energy source 126 and coupling chamber 124. Use of megasonic energy is, however, preferred because it is more effective at removing smaller particles from the tissue surface. Although the megasonic device used in system 100 can have outputs as high as 5 Watts/cm² and higher, it is preferable to use an output of 3 Watts/cm² and lower. Suitable equipment for generating megasonic energy is commercially available from a variety of vendors. Such equipment should, however, preferably include a generator and a series special transducers or the like. By way example, megasonic devices, which are commercially available from Kaijo Corporation of Japan and PCT Systems, Inc. of Fremont, Calif. work well.

A typical process in system 100 for producing the cleaning solution begins when a solvent stream 102, typically a stream of deionized water, flows into mixing chamber 106. Similarly, a solute stream 104 enters the same chamber 106 so mixing may commence. Solute is typically any solute that facilitates removal of a particulate contaminant from the tissue surface. In certain embodiments of the present invention, the solute is ammonium hydroxide as either a concentrated solution in liquid form or as an aqueous solution. In a preferred embodiment, the solute is typically ammonia gas, which allows using ammonium hydroxide in extremely low concentrations. In such preferred embodiments, before mixing ammonia gas with deionized water, it is filtered to bring its purity to 99.99999%. Those skilled in the art will recognize that depending on the types of contaminants to be removed from the tissue surface, other types of solutes, different from ammonium hydroxide, may be used. By way of example, a solution includes other chemicals, such as O₃, H₂O₂, and NH₄OH. These solutes are usually mixed with deionized water to a solution which is subsequently used for cleaning. The concentration of the mixing solution is generally between about 1×10⁻⁶ and about 1×10⁻⁹, and preferably between about 3×10⁻⁵ and about 1×10⁻⁶.

By activating valve 108, a solution formed in mixing chamber 106 that is in its uncharged state, is conveyed to charging chamber 110 for charging. An acoustic energy source 126, preferably a megasonic device, through a coupling chamber 124 supplies sufficient energy to charge the fluid to create a coherent liquid inside charging chamber 110. As a result, inside chamber 110, a relatively dilute solution is transformed from an uncharged state to a charged state by the aid of a megasonic device.

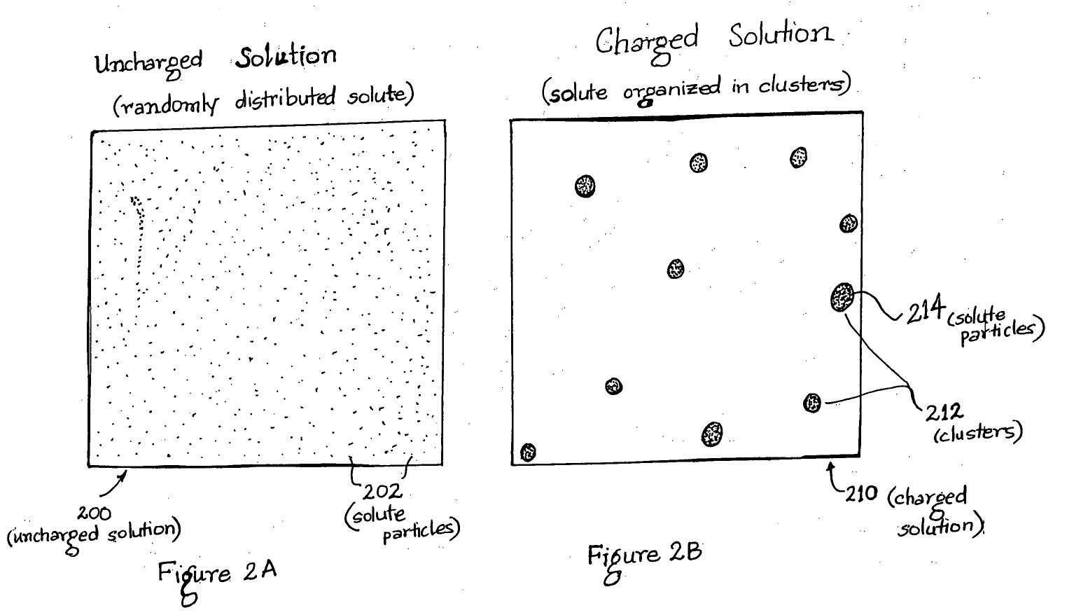

FIGS. 2A and 2B illustrate the difference in solute particle distribution from a solution's uncharged state to a charged state. In FIG. 2A, which shows an uncharged solution 200, solute particles 202 are randomly distributed throughout solution 200. In FIG. 2B, which shows a charged solution 210, solute particles 214 are organized in solution 210 as clusters 212. In a preferred embodiment of the present invention, an average number of molecules of solute 214 in clusters 212 is between about 100 and about 200 molecules per cluster. Those skilled in the art will recognize that in each of solutions 200 and 210, the solute particles are dissolved in a solvent, which is not shown in FIGS. 2A and 2B to simplify illustration and facilitate discussion. Furthermore, clusters 212 need not have a circular shape with a smooth exterior, as shown in FIG. 2B. Rather, clusters 212 are generally of any irregular shape.

The charged solution exiting charging chamber 110 has solute present in the solvent in a volumetric ratio that is between about 5×10⁻⁵:1 and about 1×10⁻²⁴:1, preferably between about 1×10⁻⁶:1 and about 1×10⁻²⁴:1 and more preferably between about 1×10⁻⁸:1 and about 1×10⁻²⁴:1. It is important to note, however, that after the first charging action in chamber 110, the exiting solution sometimes may not be charged to the desired extent.

To this end, in preferred embodiments as shown in FIG. 1, system 100 is designed to charge to a greater extent a charged solution stream flowing out of charging chamber 110. Second, third and fourth connections 112, 114 and 120 define a pathway that facilitates, among other things, diluting this charged solution using more solvent from solvent stream 102 and conveying the diluted solution to charging chamber 110 for further charging. In such dilute charged solution, solute is present in a solvent in a volumetric ratio that is between about 5×10⁻⁵:1 and about 1×10⁻²⁴:1. This preferred embodiment, provides the flexibility of using small amounts of charged solution residing in charging chamber 110 and further diluting it to produce a more effectively charged solution.

The charged solution obtained by activating valve 122 of FIG. 1 has a composition for promoting oral hygiene. This composition primarily includes a solute, which selected to promote cleaning of tissue present in mouth. An active ingredient responsible for detaching contaminants from the tissue surface is typically present in the cleaning solution as the solute. For example, the solute is one member selected from the group consisting of mouth wash and diluted solution containing tooth paste. In the present invention, when the cleaning solution is in a charged state, at least a portion of the solute is present in cluster form in said solution. Cleaning mouth tissue using solute clusters represents a marked improvement over the conventional cleaning compositions. In conventional cleaning compositions, the solute, which is typically present in relatively high concentrations, may be able to temporarily detach the contaminant from the mouth tissue by a chemical reaction at the tissue surface. However, the detached contaminant may not have sufficient energy to be completely removed from the tissue surface. The contaminants, as a result, return and adhere to the tissue surface. In the composition, according to the present invention, the solute clusters trap the detached contaminant particle and effectively prevent it from returning to the tissue surface. Accompanying mechanical action during cleaning, such as a user's brushing or rinsing action, remove the trapped contaminant from the mouth.

To use the inventive cleaning compositions for removing contaminants from mouth tissue requires, among other things, applying the above-described charged solution to the mouth tissue present in mouth, and providing sonic energy to the charged solution contained in the mouth. The present invention relies upon very high pH of the charged near-zero solute dilutions in the cleaning solution to capture and remove the contaminants, whose detachment is aided by using sonic energy. In preferred embodiments of the present invention, megasonic energy, in addition to the presence of charged solution, is applied to the mouth tissue to facilitate the removal of the contaminants from the tissue surface.

In accordance with one embodiment of the present invention, a sonic tooth brush equipped with a mechanism of providing the solution to the mouth tissue is used. The mechanism, for example, conveys the charged solution to the mouth tissue from a reservoir of the charged solution, which may or may not be a component of the sonic tooth brush. Furthermore, the same sonic tooth brush is also useful for applying the necessary sonic energy mentioned above. As a result, a single sonic tooth brush, which includes a mechanism of providing the charged solution to the mouth tissue, can be used to do both apply the charged solution and provide sonic energy to the mouth tissue for effective cleaning. In an alternative embodiment, both of these steps of the present invention can similarly be carried out by a dental tray.

Although certain examples have been described in terms of cleaning semiconductor substrates, those skilled in the art will recognize that the inventive systems, methods and compositions described herein can be used for cleaning other objects that may be in the mouth that are not tissue. For example, the inventive systems, methods and compositions can be used for effective cleaning of braces and dentures.

What is claimed is:

1. A method for producing a solution which promotes oral hygiene, comprising charging a solution, which contains at least a solute selected to promote cleaning of tissue present in mouth, wherein as a result of said charging, at least a portion of said solute is present as clusters in said charged solution.

2. The method of claim 1, wherein said charging is carried out by vibrating said solution to produce at least said portion of said solute in cluster form.

3. The method of claim 2, wherein said vibrating is caused by sonic energy.

4. The method of claim 3, wherein said vibrating is caused by ultrasonic energy or megasonic energy.

5. The method of claim 4, wherein said tissue present in mouth includes any one selected from the group consisting of tongue, teeth and gums.

6. The method of claim 1, wherein said solute is any one selected from the group consisting of ammonium hydroxide, mouthwash and diluted solution of tooth paste.

7. The method of claim 1, wherein an average number of molecules of said solute in said clusters is between about 100 and about 200 molecules per cluster.

8. The method of claim 1, wherein said charging further comprising diluting said solution such that said solute is present in a solvent in a volumetric ratio that is between about 5×10⁻⁵:1 and about 1×10⁻²⁴:1.

9. The method of claim 8, wherein said solute is present in said solvent in a volumetric ratio that is between about 1×10⁻⁶:1 and about 1×10⁻²⁴:1.

10. The method of claim 9, wherein said solute is present in said solvent in a volumetric ratio that is between about 1×10⁻⁸:1 and about 1×10⁻²⁴:1.

11. The method of claim 1, further comprising:
diluting said charged solution to produce a cleaning solution; and
using said cleaning solution for promoting said oral hygiene.

12. The method of claim 1, wherein said charging includes applying acoustic energy for producing said clusters.

13. The method of claim 12, wherein said acoustic energy is produced by a sonic device.

14. The method of claim 1, further comprising mixing a solvent and said solute to produce said solution before said charging said solution.

15. The method of claim 14, wherein said solvent is deionized water.

16. The method of claim 14, wherein said mixing produces said solution having said solute present in said solvent in a volumetric ratio that is between about 3×10⁻⁵:1 and about 1×10⁻²⁴:1.

17. A system for making a cleaning solution which promotes oral hygiene, comprising:
a charging chamber for holding a solution, which contains at least a solute selected to promote oral hygiene; and
a first acoustic energy source capable of vibrating said solution in said charging chamber to produce a charged solution, wherein at least a portion of said solute is present as clusters in said charged solution.

18. The system of claim 17, further comprising a mixing chamber for mixing a solvent and said solute to produce said solution.

19. The system of claim 18, further comprising a connection which allows communication between said charging chamber and an exit stream of said mixing chamber such that said solvent and solute combine with the contents of said charging chamber to produce an effective cleaning solution.

20. A method for facilitating oral hygiene, comprising:
applying a charged solution to tissue present in mouth; and
providing sonic energy to the charged solution contained in the mouth.

21. The method of claim 20, wherein said applying and said providing is carried out by a sonic tooth brush that includes a mechanism of providing said charged solution within said mouth and provides sonic energy when said sonic tooth brush is activated.

22. The method of claim 21, wherein said applying and said providing is carried out by a dental tray which contains said charged solution and said dental tray includes a mechanism of providing sonic energy when said mechanism is activated.

23. The method of claim 20, wherein said providing is carried out at ultrasonic energy.

24. A composition of a solution for promoting oral hygiene, comprising:
a solute selected to promote cleaning of tissue present in mouth, wherein at least a portion of said solute is present in cluster form in said solution.

25. The composition of claim 24, wherein said solute and solvent are present in a volumetric ratio that is between about 1:1 and about 1×10⁻²⁴:1.

26. The composition of claim 24, wherein said solute is ammonium hydroxide.

27. The composition of claim 24, wherein said solute is one selected from the group consisting of mouth wash, diluted solution containing tooth paste.

28. The composition of claim 24, wherein said solvent is deionized water.

29. The composition of claim 24, wherein said solute and solvent are present in a volumetric ratio that is between about 1×10⁻⁵:1 and about 1×10⁻²⁴:1.

30. The composition of claim 24, wherein said solute and solvent are present in a volumetric ratio that is between about 1×10⁻⁷:1 and about 1×10⁻²⁴:1.

31. The composition of claim 24, wherein said solute and solvent are present in a volumetric ratio that is between about 1×10⁻⁴:1 and about 1×10⁻⁸:1.

32. The composition of claim 24, wherein said tissue present in mouth includes any one member selected from the group consisting of teeth, tongue and gums.

33. A method for promoting oral hygiene, comprising:
applying a charged solution to tissue present in mouth, which contains at least a solute selected to promote cleaning of tissue present in mouth including any one of tongue, teeth and gums, wherein at least a portion of said charged solution contains solute in clusters form; and
providing sonic energy to said charged solution when it is present in said mouth to effectively remove particle matter adhering to tissue present in the mouth.
